(19) United States
(12) Patent Application Publication
(10) Pub. No.: US 2020/0387986 A1
(43) Pub. Date: Dec. 10, 2020

(54) NO BOUNDARY TRAVEL: COUNTRIES VISA GUIDE APP

(71) Applicant: Linh Luong, Cypress, CA (US)

(72) Inventor: Linh Luong, Cypress, CA (US)

(21) Appl. No.: 16/431,762

(22) Filed: Jun. 5, 2019

(51) Int. Cl. G06Q 50/14; G06F 16/9537; G06F 16/9536

(52) U.S. Cl. CPC G06Q 50/14; G06F 16/9536; G06F 16/9537

(57) ABSTRACT

A system and procedure for visa assistance to travelers planning to visit foreign countries. The system allows to present updated information to travelers regarding visas requirements, documents needed to be carried and other pre-requirements for travelling to any destination around the world using a centralized database and crowdsourcing technology. The system further allows to connect with on ground support like tourist guides, hotels bookings, flight bookings, restaurants, spa, places to visit and other information.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present disclosure relates to travel industry and more particularly relates to a global travel service including providing visa pre-requirements, destination and travel-related information, products, and services specific to a traveler's potential or previously-selected destination or destinations.

### Description of the Related Art

A visa is an official document (or stamp endorsed in a passport) issued by a foreign nation that grants you permission to enter that country for a specified period of time. Usually the application process is pretty straightforward (provided you plan ahead with plenty of time to spare). But visas for some countries can involve a little more thought and preparation. So, how do the travelers know if you need a visa for your next trip and where to get one

There are multiple solutions that have been presented in prior art to facilitate the travel process. For instance, a travel assist system bearing Chinese patent 1,821,716B is issued to Chinese inventor. The patent discloses a travel assist system searches a nearest service station based on navigation information and predicts a quantity of aqueous urea solution consumed until the service station is reached. If a quantity of the remaining aqueous urea solution is not greater than the aqueous urea solution consumption at least by a predetermined value, a warning is provided to a user. Control conditions of an internal combustion engine (diesel engine) enabling the vehicle to reach the service station without running short of the aqueous urea solution are calculated. An exhaust gas recirculation quantity is increased based on the calculation result. Thus, nitrogen oxides contained in the exhaust gas is reduced and a consumption of the aqueous urea solution is reduced.

A Self-service system for selling travel-related services or products bearing U.S. Pat. No. 5,732,398A is issued to TAGAWA RICHARD S. The patent discloses a in a self-service system of selling travel-related services or products by means of an interactive travel service system functioning like a travel agent, to simplify the search process by the system and the decision process by the user, the user is first queried as to travel knowledge, such as whether the user is a first-time visitor or is otherwise familiar with the travel destination, and as to personal attribute such as family orientation, age and preference for airlines, lodgings, car rental companies, price range and lifestyle. In accordance with the travel knowledge and attributes inputted electronically by the user, one or more recommendations or a whole listing will be presented for selection by the user. To simplify the process, the user is asked to input the relevant dates and the inventory database is searched so that only available choices will be presented. The system is particularly advantageous for self-service method of selling travel-related services or products such as local tour attractions, local bookings, car rental bookings, local or intrastate tour packages, airline tickets, out-of-state tour packages, cruises, optional tours or cruises, and other shopping options.

An automated internet based interactive travel planning and management system bearing U.S. Pat. No. 9,916,543B2 is issued to Airport America. The patent discloses an interactive rapid response Internet accessed air travel management system. The system includes a web-based planning and reservation interface system and an interactive access device. The system responds to details of a member's desired travel, to thereafter act in real time to contact the domains of associated travel service providers to arrange for every aspect of the member's trip, from airline and hotel reservations, ticket issuance, and ground transportation, to restaurant and theater reservations, and any other travel related needs of the member. The system stores identification information to verify access device possession to prohibit unauthorized use of the system and to provide security pre-clearance to system members.

A Computer travel planning system bearing U.S. Pat. No. 5,237,499A is issued to TOTAL TRAVEL MANAGEMENT Inc. The patent discloses a computer based system for processing travel requests directed to a specific venue from individual members of a sponsored group. The system comprises a data base containing a venue file including information regarding the specific venue, a group member file for each individual member of the group, a travel policy file containing information on preselected vendors of various travel services, and a city code file containing codes corresponding to a plurality of city airport locations. Data is entered and information displayed to an individual group member making a travel request via a terminal, such as a personal computer. A central processing unit is in communication with the data base and with a plurality of airline CRS systems. The CPU is programmed to select an individual group member itinerary for the specific venue which includes specific airline flights, and if necessary, specific hotel accommodations and specific rental car services.

A method and apparatus for providing travel destination information and making travel reservations bearing U.S. Pat. No. 5,422,809A is issued to Touch Screen Media Inc. The patent discloses an apparatus and Method for providing travel destination information and making travel destinations which includes an information storage and retrieval system for storing, referencing and retrieving various travel destinations from a database. A querying device queries the user for input used to define the field for the travel destination desired, while a display device displays information associated with a selected travel destination. An accessing device is provided for making travel reservations concerning a selected travel destination. The apparatus and method optionally include a reproducing device for printing information concerning travel destinations or reservations, a valuable media accepting device for accepting payment associated with travel reservations, or an accounting indicator device for accumulating statistical information on selected travel destinations.

An apparatus and method for low fare searching in a computer network bearing WIPO patent 2,000,0131,24A1 is issued to John Bamforth, Fuad Ayyash, Yasuharu Tsuji, John Lewis. The patent discloses a method and apparatus for performing low price searches in a computer network is presented. Search request data identifying a particular item is received at a processor. Availability information reflecting availability of a set of items in an inventory is then obtained, each item in the set corresponding to the particular item. After obtaining the information, it is ascertained whether the search request data includes a target price reflecting a user's price preference associated with the item. A determination is then made as to whether price information associated with each item in the set substantially satisfies the target price. After which, a selection of an item from the set is confirmed based on the determination.

A Travel planning system bearing U.S. Pat. No. 6,295,521B1 is issued to Google LLC. The patent discloses an airline travel planning system is described. The system includes a server computer executing a server process including a search process to search for set of pricing solutions in accordance with at least one destination and at least one origin. The search process represents the set of pricing solutions in the form of a directed acyclic graph. The system also includes a client computer executing a client process on the set of pricing solutions. The client process has a manipulation process that manipulates the set of pricing solutions in response to user preferences. Several processes are described including a process responsive to user preferences and to set of pricing solutions that provides pricing solutions sorted by said user preference, a process that sorts set of pricing solutions to produce a subset of said set of pricing solutions in accordance with user specified preferences, and a process that prunes from the directed acyclic graph nodes that are no longer contained within the subset of set of pricing solutions.

A reservation system bearing WIPO patent 2,001,090,970A1 is issued to Christopher Henry Seal, David John Mccartney. The patent discloses a reservation system, particularly suited to small businesses, includes a database accessible through the public switched telephone network (PSTN), an electronic diary at each serviced customer premises and a plurality of customer telephone channels connecting each customer premises to the PSTN. In use, when a potential customer contacts the supplier, the electronic diary uses the second line to effect a simultaneous call to the database. The electronic diary and corresponding data in the database are kept synchronised so that the database may be used with certainty for assisting intermediaries to determine availability at each of a number of small suppliers. Alternatively, the network may act as an intermediary, connecting calls to potential suppliers based on the information held in the database. Because the electronic diary and database are always in step small suppliers can use the system without having to pre-allocate accommodation/commodity to a particular intermediary.

A Method and system for creating travel packages bearing US patent 2,003,003,6930A1 is issued to Expedia Inc. The patent discloses an invention related in general to on-line transportation reservation processing and, in particular, to a system and method for identifying and purchasing travel packages on-line. In one embodiment, package components are retrieved by a package server in response to a query from a consumer. A best package component is identified from the retrieved package components. Then a listing of packages matching the best package component is depicted for the consumer with real-time prices to the consumer. In another embodiment of the present invention, real-time prices corresponding to travel packages are related to published fares for package components. The relationship is calculated to maximize the real-time price relative to the price for published fares for the travel components. In still another embodiment of the present invention, travel packages are cross-sold to consumers when they are seeking to purchase a travel component that may be included in a travel package.

There are multiple solutions that have been presented in prior art. However, these solutions are limited and restricted to their conventional systems. The current invention is focused on presenting a platform, providing resources for travelers such as visa requirement for travelers who want to travel across the world and have to go through multiple requirements before getting the ticket or entering the foreign country premises.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved method for assistance of travelers around the world.

It is also the primary objective of the invention to provide a smart methodology of storing the data about the visa requirements for each country and as per user's requirements display the required information on user screen.

It is another objective of the invention to provide a system where additional services like connecting to hotels, resorts, tour guides, places to be seen guide, food options and other necessary information can be presented.

It is also the object of the invention to provide an advance system where users can filter the search as per their individual requirements and can get the detailed outcome with single click.

It is also the object of the invention to provide a system where customer preference information is stored, and updated information is readily available in a database.

It is also the objective of the invention to provide the convenience where, once a user selects the required destination visa requirements, airline carriers tickets, room accommodation packages and ground support is also presented.

It is further the objective of the invention to provide an advance system that is simple, easy to use interface and convenient to implement and use.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to an advanced methodology for assisting travelers for visa requirements as per each country's laws.

In recent years, individuals have gained greater direct access to information related to travel service providers via interconnected computer networks defined broadly as “the Internet.” Such information includes airline schedules, flight availability, and limited ticketing, hotel locations and telephone numbers, and entertainment location information. However, one thing that is still missing is the complete information regarding visa requirements for any country.

The visa requirements vary for each county and also vary as per each tourist coming from any county. Gathering this set of information is always a challenge. To overcome the challenge the current invention is proposed.

The current system as per its preferred embodiments present a system which aims to provide users with visa information and pre-requirements before they plan for their vacations. The system presented is in form of connected centralized database which stores the information regarding each country requirements for visas. The database is stored centrally and keeps on updating the information so that the visa information should remain up-to-date.

The current system as per its further embodiments allows to save customer profiles and show them the visa requirements, visa bulletins and updates on requirements once user selects his upcoming travel plans. The customer profiles are stored on central location so that it can be displayed to user regardless of their location.

The system as per its further embodiments aims to presents the user with information comprising data base further includes a travel policy requirement which contains further information on airline carriers, room accommodation providers, and ground transportation providers.

The system as per its further embodiments presents the airline flights options dates and cost wise, hotel rooms and car rental services. It also helps to connect with travel guides and other local resources for effective planning. The system further aims to utilize the Crowdsourcing model in which individuals or organizations can obtain updated information, from a large, relatively open and often rapidly-evolving group of internet users; to achieve a cumulative and updated results from the community of users.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: An automated system to provide visa information and travel pre-requirements comprising:
database operable to store traveler portfolio information comprising at least a traveler's preferences, and portfolio country wise consisting of updated visa related information comprising a set of competing preferences;
and a processor connected to said database and operable to: receive travel request information from a customer system;
access said database to retrieve the traveler portfolio information and the country portfolio information in response to said received travel request information;
displaying the required information in tabular form for enhanced graphical user interface and
utilizing the Crowdsourcing platform for updated and hands-on information.

II: The automated system assisting travelers by helping them to connect with local tourist guides, on ground transportation services, hotel arrangements and other supports required at each place.
